(19) United States
(12) Patent Application Publication
(10) Pub. No.: US 2019/0244231 A1
(43) Pub. Date: Aug. 8, 2019

(54) BENEFIT SELECTION APPARATUS, METHOD FOR SELECTING BENEFIT, AND INFORMATION TERMINAL

(71) Applicant: TOYOTA JIDOSHA KABUSHIKI KAISHA, Toyota-shi (JP)

(72) Inventors: Kazuhiro UMEDA, Nisshin-shi (JP); Takumi FUKUNAGA, Nisshin-shi (JP); Makoto AKAHANE, Nagoya-shi (JP); Satoshi USUI, Machida-shi (JP)

(73) Assignee: TOYOTA JIDOSHA KABUSHIKI KAISHA, Toyota-shi (JP)

(21) Appl. No.: 16/266,241

(22) Filed: Feb. 4, 2019

(30) Foreign Application Priority Data
Feb. 8, 2018 (JP) 2018-021306

(51) Int. Cl. G06Q 30/02

(52) U.S. Cl. CPC G06Q 30/0207; G06Q 30/0283

(57) ABSTRACT

A benefit selection apparatus includes at least one processor configured to calculate, based on information on a travel route of a vehicle used by a user and on traffic congestion information, a congested travel record of the vehicle traveling in a congested section, and select a benefit corresponding to the congested travel record as a benefit awarded to the user.

### INCORPORATION BY REFERENCE

The disclosure of Japanese Patent Application No. 2018-021306 filed on Feb. 8, 2018 including the specification, drawings and abstract is incorporated herein by reference in its entirety.

### BACKGROUND

### 1. Technical Field

The present disclosure relates to a benefit selection apparatus, a method for selecting a benefit, and an information terminal.

### 2. Description of Related Art

Japanese Patent Application Publication No. 2009-048357 (JP 2009-048357 A) discloses a technique for a car sharing system. In the car sharing system, a use fee is calculated in accordance with scheduled use frequency of a user within a fixed time. As the use fee increases, more share points are awarded to the user, while a user having a large point balance is entitled to preferential use reservation.

### SUMMARY

In JP 2009-048357 A, a user having a high use frequency can make a preferential reservation. However, in order to promote use of all the users, it is not sufficient to provide high reservation priority to some users. For example, in a car sharing service, metered charging in which a use fee is increased according to use time is often used. In the case of charging based on an amount, the use fee increases with an occurrence of traffic congestion. This causes a problem of a decline in use of the car sharing service at the places or time periods where traffic congestion tends to occur.

Accordingly, the present disclosure provides a benefit selection apparatus, a method for selecting a benefit, and information terminal, capable of encouraging users to use the car sharing service even at the places or time periods where traffic congestion tends to occur.

A benefit selection apparatus according to one aspect of the present disclosure includes at least one processor. The at least one processor is configured to calculate, based on information on a travel route of a vehicle used by a user and on traffic congestion information, a congested travel record of the vehicle traveling in a congested section, and select a benefit corresponding to the congested travel record as a benefit awarded to the user.

The aspect may further include a transmission module configured to transmit to the user details of the benefit selected by the at least one processor.

In the aspect, the benefit may be a discount on a use fee of the vehicle, and the at least one processor may calculate the fee charged for use of the vehicle by applying details of the discount corresponding to the congested travel record.

In the aspect, the discount may be set higher as the congested travel record increases, with an upper limit of the discount provided in consideration of the use fee to which the details of the discount are applied.

In the aspect, the congested travel record may be at least one of a congested travel distance and a congested travel time of the vehicle traveling in the congested section.

A method for selecting a benefit according to a second aspect of the present disclosure includes: calculating and selecting. The calculating is for calculating, based on information on a travel route of a vehicle used by a user and on traffic congestion information, a congested travel record of the vehicle traveling in a congested section. The selecting is for selecting a benefit corresponding to the congested travel record as a benefit awarded to the user.

An information terminal according to a third aspect of the present disclosure includes: a transmission module and a display. The transmission module is configured to repeatedly transmit, while a vehicle equipped with the information terminal is used by a user, information on a current location of the information terminal and a time as information on a travel route of the vehicle The display is configured to receive and display details of a benefit corresponding to a congested travel record that is at least one of a congested travel distance and a congested travel time of the vehicle traveling in a congested section, the congested travel record being calculated based on the information of the travel route and on traffic congestion information.

The present disclosure can provide a benefit selection apparatus, a method for selecting a benefit, and information terminal, capable of encouraging users to use a car sharing service even at the places or time periods where traffic congestion tends to occur.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 illustrates the configuration of a car sharing system according to an embodiment; and

FIG. 2 is a sequence chart for describing one example of the operation of the car sharing system according to an embodiment.

### DETAILED DESCRIPTION OF EMBODIMENTS

Preferred embodiments of the present disclosure will be described with reference to the accompanying drawings. In the drawings, identical or like component members are designated by identical or like reference signs.

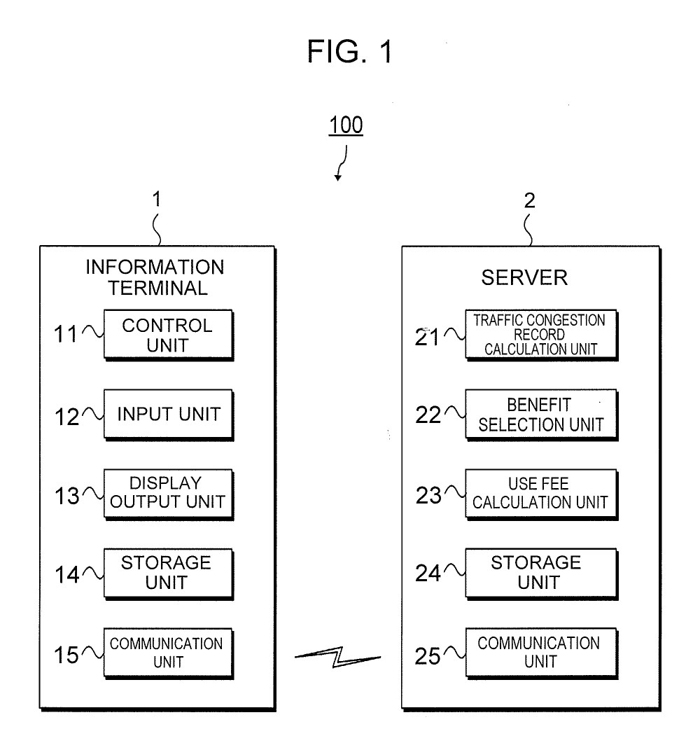

With reference to FIG. 1, the configuration of the car sharing processing system according to an embodiment will be described. A car sharing system 100 includes, for example, an information terminal 1 mounted on a vehicle subjected to car sharing, and a server (benefit selection apparatus) 2 that manages a vehicle subjected to car sharing and calculates a use fee of the car sharing service. The information terminal 1 and the server 2 are configured to be communicable with each other via a network including a radio network, for example.

For example, the information terminal 1 shown in FIG. 1 is a terminal device, such as onboard equipment, or a car navigation device. The information terminal 1 has, for example, a control unit 11, an input unit 12, a display-output unit 13, a storage unit 14, and a communication unit 15 (transmission module) as functional components. The information terminal 1 is configured by including, for example, a control unit (processor) including a central processing unit (CPU) and a memory, an operation unit, a display, a speaker, a storage unit, and a communication unit as physical component members. When the CPU executes specified programs stored in the memory, each function of the control unit 11, the input unit 12, the display-output unit 13, the storage unit 14, and the communication unit 15 is implemented.

The server 2 has, for example, a traffic congestion record calculation unit 21, a benefit selection unit 22, a use fee calculation unit 23, a storage unit 24, and a communication unit (transmission module) 25 as functional component members. The server 2 is configured by including, for example, a control unit (processor) including a CPU and a memory, a storage unit, and a communication unit as physical components. When the CPU executes specified programs stored in the memory, each function of the traffic congestion record calculation unit 21, the benefit selection unit 22, the use fee calculation unit 23, the storage unit 24, and the communication unit 25 is implemented.

The server 2 stores and manages vehicle information corresponding to each vehicle subjected to car sharing in a database or the like. The vehicle information includes, for example, a vehicle ID that identifies a vehicle, vehicle use status information, and vehicle travel route information.

The vehicle use status information includes, for example, information indicating whether or not the vehicle is in use by a user, a user ID that identifies the user using the vehicle, a use start time, a use start place, a scheduled return time, and a scheduled return place.

The vehicle travel route information includes, for example, a positioning time, and location information and speed information at the positioning time. The vehicle travel route information is repeatedly transmitted from the information terminal 1, while the vehicle is used by the user. The timing of transmission may be, for example, every prescribed time, or may be every specified distance.

The server 2 manages traffic information including traffic congestion information by, for example, collecting the information at any time from a traffic information center or the like, and storing the collected information in a database or the like. The traffic congestion information includes a traffic congestion occurrence time, a traffic congestion occurrence section, a travel speed, and a traffic congestion alleviation time. The traffic congestion information can be divided into divisions (hereinafter, also referred to as “traffic congestion divisions”) by travel speed and be managed accordingly. The traffic congestion divisions may separately be provided for general roads and for highways.

The traffic congestion divisions for highways will be described with specific examples. The traffic congestion divisions for highways may include, for example, less than 10 km per hour, 10 km to less than 20 km per hour, 20 km to less than 30 km per hour, and 30 km to less than 40 km per hour.

Among each of the functions included in the server 2, the traffic congestion record calculation unit 21, the benefit selection unit 22, the use fee calculation unit 23, and the communication unit 25 will be described below in detail.

The traffic congestion record calculation unit 21 calculates, based on information on a travel route of a vehicle used by a user and on traffic congestion information, a congested travel record that is a record of the vehicle traveling in a congested section. The congested travel record includes, for example, a distance of the vehicle traveling in a congested section (hereinafter, also referred to as “congested travel distance”), and a time of the vehicle traveling in the congested section (hereinafter, also referred to as “congested travel time”).

Specifically, the traffic congestion record calculation unit 21 can identify, based on the travel route information, when a vehicle traveled on which road, and compare the identified information with a traffic congestion occurrence time, a traffic congestion occurrence section, a traffic congestion alleviation time, and the like included in the traffic congestion information to calculate a congested travel record.

Here, the congested travel distance and the congested travel time may be calculated for every traffic congestion division. Both the congested travel distance and the congested travel time may be used as a congested travel record, or one of the congested travel distance and the congested travel time may be used. In the following description, the congested travel distance is exemplarily used as a congested travel record for the sake of convenience.

The benefit selection unit 22 selects a benefit corresponding to the congested travel distance as a benefit awarded to a user. The benefit includes, for example, a discount on the use fee of a vehicle, a point, a cashback, a coupon, and courtesy services. In the following description, a discount on the use fee of a vehicle is exemplarily awarded as a benefit for the sake of convenience.

The discount details may be set with use of a discount rate applied to the use fee, or may be set with use of the amount of money discounted from the use fee. The discount details are set for every division of the congested travel distance (hereinafter, also referred to as “congested travel distance division”). As the congested travel distance is longer, the discount rate or amount is set higher.

When the discount details are set with use of the discount rate, the discount details may be set as shown below, for example. When the congested travel distance is less than 5 km, the discount rate is set to 2%. When the congested travel distance is 5 km to less than 10 km, the discount rate is set to 5%. When the congested travel distance is 10 km to 20 km, the discount rate is set to 8%. When the congested travel distance is 20 km or more, the discount rate is set to 10%.

When the discount details are set with use of the amount of money, the discount amount is set for every congested travel distance, with an upper limit of the discount amount being preferably set within each use fee. For example, when the use fee is 8,000 yen, 2,400 yen may be set as an upper limit of the discount amount. When the use fee is 10,000 yen, 3,000 yen may be set as an upper limit of the discount amount. A specified percentage (for example, 30%) of the use fee may uniformly be set as an upper limit amount.

Here, in the case of calculating the congested travel distance in every traffic congestion division, congested travel distance divisions may be provided for every traffic congestion division, and the discount details as a benefit may be set for every congested travel distance division. In this case, when the discount details relate to a discount rate, the discount rate may be selected for every traffic congestion division. For example, a ratio of a travel distance at each traffic congestion division to the congested travel distance may be multiplied by each corresponding discount rate, and obtained values may be accumulated as a benefit corresponding to the congested travel distance. When the discount details relate to the amount of money, the amount of money may be selected for every congested section, and the sum of the amounts of money may be used as a benefit corresponding to the congested travel distance.

The use fee calculation unit 23 applies the discount details corresponding to a congested travel distance, and calculates the fee charged for use of a vehicle. A concrete description will be provided below. For example, when the congested travel distance is 8 km, the discount rate is 5% in the case described before. In this case, when the use fee before discount is 10,000 yen, the use fee calculation unit 23 calculates 9,500 yen (10,000 yen×0.95) as a fee charged for use of the vehicle.

The communication unit 25 transmits to the information terminal 1 a message including the discount details selected by the benefit selection unit 22 and the fee charged for use of the vehicle calculated by the use fee calculation unit 23. For example, a message “discount rate of 5% is applied for congested travel distance of 8 km. The fee charged for use of the vehicle is 9,500 yen” is transmitted to the information terminal 1. Thus, the message may be displayed on the display of the information terminal 1, or be output by voice from the speaker of the information terminal 1. Hence, the user is notified of the discount details corresponding to the congested travel distance, and the discounted fee.

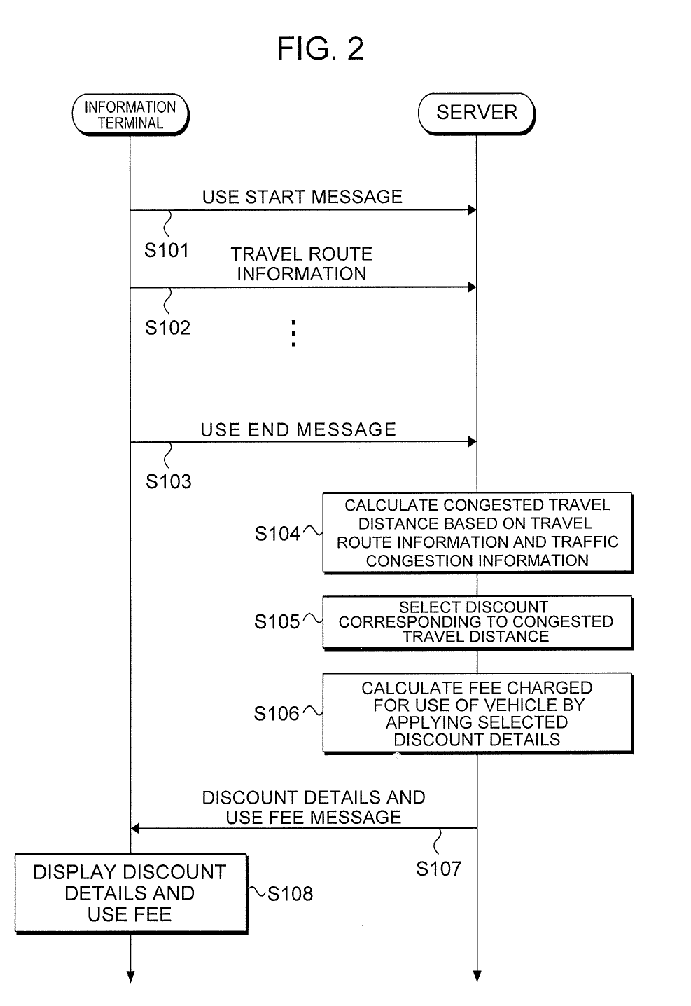

With reference to FIG. 2, one example of the operation of the car sharing system 100 in an embodiment will be described.

First, when the use start time of a user vehicle has come, the information terminal 1 transmits a use start message to the server 2 (step S101). The information terminal 1 may transmit the use start message in response to an operation instruction of a user.

Next, the information terminal 1 repeatedly transmits travel route information to the server 2 for every prescribed time, for example (step S102).

Next, when the use end time of the user vehicle has come, the information terminal 1 transmits a use end message to the server 2 (step S103). The information terminal 1 may transmit the use end message in response to an operation instruction of the user.

The traffic congestion record calculation unit 21 of the server 2 then calculates a congested travel distance included in the record of the vehicle traveling in a congested section, based on the travel route information received in step S102 and on traffic congestion information (step S104).

Next, the benefit selection unit 22 of the server 2 selects a discount corresponding to the congested travel distance calculated in step S104 as a benefit awarded to the user (step S105).

The use fee calculation unit 23 of the server 2 then calculates the fee charged for use of the vehicle by applying the discount details selected in step S105 (step S106).

Next, the communication unit 25 of the server 2 transmits to the information terminal 1 a message including the discount details selected in step S105 and the fee charged for use of the vehicle calculated in step S106 (step S107).

The information terminal 1 then displays a message including the discount details and the fee charged for use of the vehicle on the display (step S108).

Here, since the benefit is a discount in the above embodiment, the use fee of the vehicle is calculated by applying the discount details in step S106. However, this process is not an essential component member. For example, when the benefit relates to point awarding or cashback, which is performed later without being reflected on the use fee on the spot, the fee calculating process that involves application of the discount details by the use fee calculation unit 23 may be omitted. In this case, for example, the process of calculating a normal use fee, and the process for awarding points, cashback, or the like to the user may be executed, and the process for notifying the user of the awarded points and cashback may further be executed.

As described before, in the car sharing system 100 in the embodiment, the server 2 can calculate, based on the information on the travel route of the vehicle and the traffic congestion information, the congested travel distance that is a congested travel record of the vehicle traveling in a congested section, and can select a discount rate corresponding to the congested travel distance as a benefit awarded to the user. The server 2 can further calculate the use fee of the vehicle by applying the selected discount rate, and transmit the use fee and the discount rate to the information terminal 1.

That is, it becomes possible to award, to the user using the vehicle that traveled in a congested section, a discount rate as a benefit in accordance with the distance (record) of the travel in the congested section, and to calculate the use fee by applying the discount rate.

According to the car sharing system 100 in the embodiment, the information terminal 1 can repeatedly transmit, while the vehicle is used by the user, the information on the current location of the information terminal and the time as the information on the travel route of the vehicle equipped with the information terminal, and can receive and display the discount rate corresponding to the congested travel distance calculated based on the travel route information and on the traffic congestion information, and the information regarding a discounted use fee.

That is, when a user traveled in a congested section, the user can confirm the discount rate awarded in accordance with the record of the travel distance and the use fee to which the discount rate is applied.

Therefore, the car sharing system 100 in the embodiment can encourage the user to use the car sharing service even in the places and time periods where traffic congestion tends to occur.

Modifications

The present disclosure is not limited to the embodiments disclosed, but may be performed in other various forms without departing from the scope of the present disclosure. Therefore, the embodiments disclosed are in all respects illustrative and are not considered as the basis for restrictive interpretation. For example, the order of the processing steps described before may optionally be changed or executed in parallel without causing inconsistency in the contents of the process.

The embodiments disclosed have been described on the assumption that the information terminal 1 is onboard equipment or a car navigation device mounted on a vehicle. However, the present disclosure is not limited to this. The information terminal 1 may be a portable terminal device, represented by a smartphone or the like, that can be held by a use, for example. In this case, for example, an application for a car sharing service and an application for navigation may be installed in the portable terminal device, and the travel route information may be transmitted to the server 2 with use of the application for navigation.

The component members of the information terminal 1 and the server 2 are not limited to the component members in the embodiments disclosed. Any component members may suitably be added as necessary.

What is claimed is:

1. A benefit selection apparatus, comprising at least one processor configured to calculate, based on information on a travel route of a vehicle used by a user and on traffic congestion information, a congested travel record of the vehicle traveling in a congested section, and select a benefit corresponding to the congested travel record as a benefit awarded to the user.

2. The benefit selection apparatus according to claim 1, further comprising a transmission module configured to transmit to the user details of the benefit selected by the at least one processor.

3. The benefit selection apparatus according to claim 1, wherein
the benefit is a discount on a use fee of the vehicle, and
the at least one processor calculates the use fee of the vehicle by applying details of the discount corresponding to the congested travel record.

4. The benefit selection apparatus according to claim 3, wherein the discount is set higher as the congested travel record increases, with an upper limit of the discount provided in consideration of the use fee to which the details of the discount are applied.

5. The benefit selection apparatus according to claim 1, wherein the congested travel record is at least one of a congested travel distance and a congested travel time of the vehicle traveling in the congested section.

6. A method for selecting a benefit, comprising:
calculating, based on information on a travel route of a vehicle used by a user and on traffic congestion information, a congested travel record of the vehicle traveling in a congested section; and
selecting a benefit corresponding to the congested travel record as a benefit awarded to the user.

7. An information terminal, comprising:
a transmission module configured to repeatedly transmit, while a vehicle equipped with the information terminal is used by a user, information on a current location of the information terminal and a time as information on a travel route of the vehicle; and
a display configured to receive and display details of a benefit corresponding to a congested travel record that is at least one of a congested travel distance and a congested travel time of the vehicle traveling in a congested section, the congested travel record being calculated based on the information on the travel route and on traffic congestion information.
